(19) United States
(12) Patent Application Publication
(10) Pub. No.: US 2014/0174655 A1
(43) Pub. Date: Jun. 26, 2014

(54) POLISHING TOOL WITH DIAPHRAM FOR UNIFORM POLISHING OF A WAFER

(71) Applicant: HGST NETHERLANDS B.V., Amsterdam (NL)

(72) Inventors: Sergey Grinberg, Mountain View, CA (US); David A. Hansen, Palo Alto, CA (US); Tom K. Harris, III, Morgan Hill, CA (US); Junsheng Yang, San Jose, CA (US); Honglin Zhu, Fremont, CA (US)

(73) Assignee: HGST NETHERLANDS B.V., Amsterdam (NL)

(21) Appl. No.: 13/725,805

(22) Filed: Dec. 21, 2012

(51) Int. Cl. G11B 5/127

(52) U.S. Cl. CPC G11B 5/127
USPC 156/345.13; 269/20; 269/21; 156/345.14

(57) ABSTRACT

A chemical mechanical polishing to that can provide uniform polishing across a wafer even when polishing hard wafers such as AlTiC wafers used in the formation of magnetic recording sliders. The chemical mechanical polishing to has a wafer carrier that includes a diaphragm or bladder that is configured such that an inner portion of the bladder can be pneumatically pressurized so as to bow outward, while outer portions remain unpressurized.

### FIELD OF THE INVENTION

The present invention relates to wafer fabrication and more particularly to a tool for polishing a wafer that provides uniform polishing across a wafer such as an AlTiC wafer used for fabrication of magnetic recording sliders.

### BACKGROUND OF THE INVENTION

Chemical mechanical polishing, commonly referred to as CMP, is a method of planarizing or polishing substrates. CMP may be used as the final preparation step in the fabrication of substrates from semiconductor slices to provide substantially planar front and back sides thereon. CMP is also used to remove high elevation features, or other discontinuities, which are created on the outermost surface of the substrate during the fabrication of microelectronic circuitry on the substrate.

In a typical CMP process, a large rotating polishing pad, which receives a chemically reactive slurry thereon, is used to polish the outermost surface of the substrate. To position the substrate on the polishing pad, the substrate is located in a carrier. The carrier is received on, or directly above, the polishing pad, and it maintains a bias force between the surface of the substrate and the rotating polishing pad. The carrier may also oscillate, or rotate the substrate on the polishing pad. The movement of the slurry whetted polishing pad across the planar face of the substrate causes material to be chemically and mechanically polished from that face of the substrate.

In addition to use in manufacturing and processing Si disks for semiconductor circuits, CMP is also used in the processing of wafers that are used as substrates for the manufacture of sliders for magnetic data recording. A slider is a structure that is configured to fly over a magnetic media in a magnetic data recording system in order to record or read data from the magnetic media. A slider is generally formed as a rectangular prism having an air bearing surface and a magnetic head formed on its trailing edge. Such sliders are formed from wafers constructed of a hard material such as AlTiC. Many thousands of read/write heads are formed on such a wafer. The wafer is then sliced into rows of sliders and processed to form a desired topography on the air bearing surface in order to promote a desired flight profile over the magnetic disk.

CMP is used in the manufacturing of such wafers, not only to produce a smooth flat surface on the wafer before forming magnetic heads thereon, but also in the actual manufacture of the heads thereon. For example, CMP can be used to remove certain topography and mask structures in the formation of a read sensor of the magnetic head or in the manufacture of a magnetic writer of the magnetic head. One challenge of using CMP in the processing of such wafers arises as a result of the increased hardness of such wafers as compared to relatively softer Si/Ge wafers. The increased Young's module of such AlTiC wafers makes it more difficult for them to respond to carrier applied forces. This for example has caused CMP processes to be non-uniform across a wafer, such as with slower material removal at the center of the wafer and increased material removal at the outer periphery of the wafer. In the magnetic slider industry, engineers have been struggling for many years to find a way to solve this problem in order to provide better CMP uniformity across the wafer. Approaches such as in-situ pad conditioning can alleviate the problem, but cannot fundamentally solve the problem. In addition, in-situ pad conditioning results in increased cost of ownership and increased process defects such as scratches. Therefore, there remains a need for providing uniform CMP process control across a wafer, especially in the processing of hard wafers such as AlTiC wafers used in the manufacture of magnetic data recording sliders.

### SUMMARY OF THE INVENTION

The present invention provides a wafer carrier that includes a bladder having an inner portion and an outer portion, and a pneumatic supply configured for pressurizing the inner portion of the bladder without pressurizing an outer portion of the bladder.

The water carrier can further include a bladder holder; and an inner zone plate located between the bladder and the bladder holder, the inner zone plate being configured to engage the bladder so as to form an air space at the inner portion of the bladder. The bladder can be configured with a raised ring that is configured to engage the inner zone plate, and which defines a boundary between the inner portion and outer portion.

The wafer carrier advantageously applies increased polishing pressure to an inner portion of a wafer held thereon so as to increase the polishing rate at the inner portion of the wafer. The amount of this increase in polishing rate can be controlled by controlling the amount of pneumatic pressure applied.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a chemical mechanical polishing tool, illustrating polishing of a wafer thereon;

FIG. 2 is a top down view of a carrier and ring mounted thereon;

FIG. 3 is an exploded view of a carrier assembly; and

FIG. 4 is a cross sectional view of the carrier with a wafer mounted thereon.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

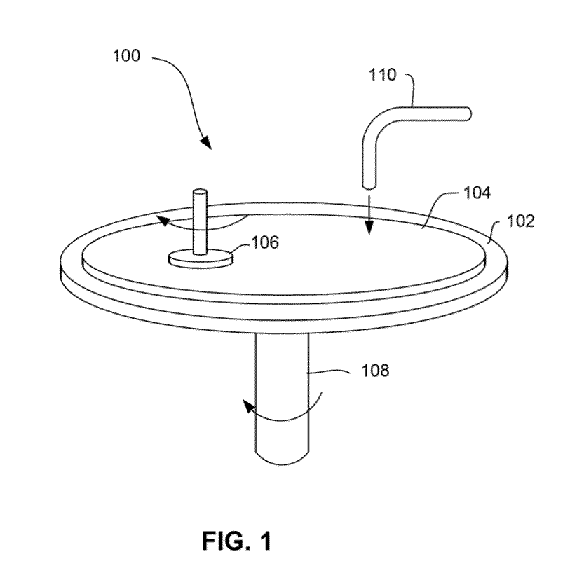

FIG. 1 is a schematic view of a chemical mechanical polishing (CMP) tool 100 in which an embodiment of the invention may be implemented. The CMP tool 100 includes a carrier structure 106 configured to hold a workpiece wafer. The carrier head structure 106 will be described in greater detail herein below. A polishing pad 104 is provided and configured to move across a surface of the wafer in order to polish the wafer. The polishing pad 104 is attached to the platen 102, to control the movement of the polishing pad 104 over the surface of the wafer and preferably to rotate the polishing pad 104 during the chemical mechanical polishing.

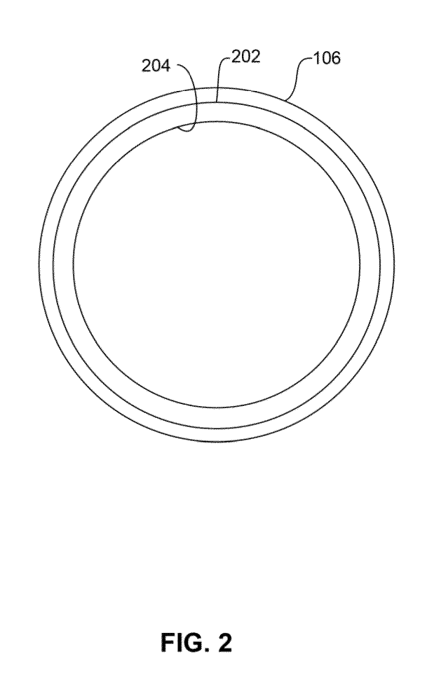

FIG. 2 shows a top down view of the carrier 106 configured for holding a wafer thereon. The carrier 106 includes a ring 202 mounted thereon that has an opening 204 that is configured for receiving a water and holding the wafer thereon. Gravity and the force of the polishing pad 106 (FIG. 1) hold the wafer against onto the carrier, and the ring prevents lateral movement of the wafer on the carrier during polishing.

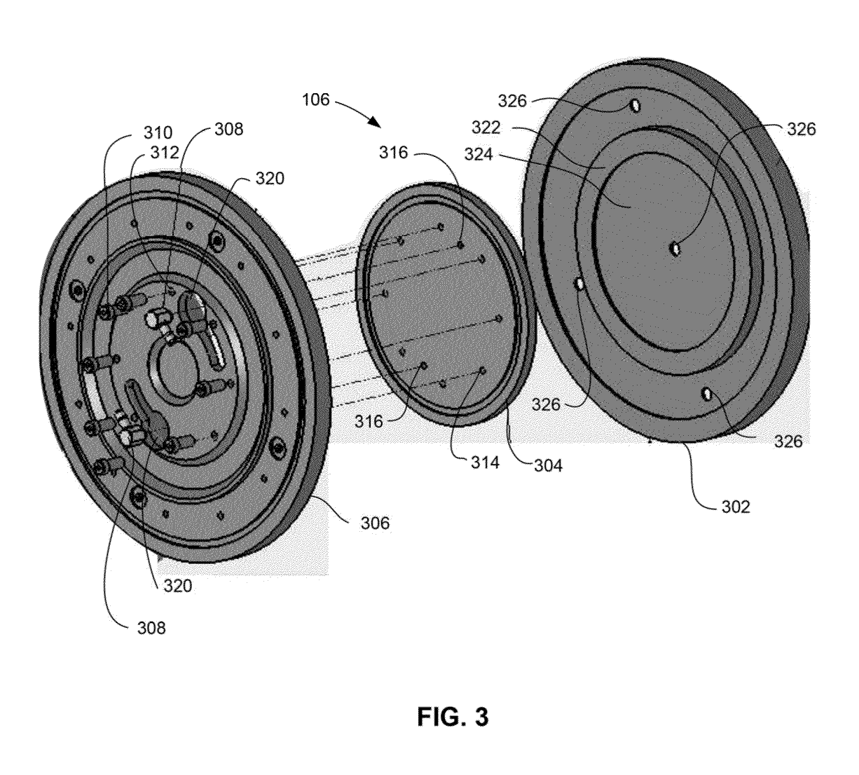

FIG. 3 shows an exploded view of several elements of the carrier 106. The carrier includes a bladder 302 that is configured to hold the wafer (not shown in FIG. 3). The bottom side of the bladder 302 is shown in FIG. 3. The wafer would actually rest on the side of the bladder 302 that is opposite the side shown in FIG. 3. The carrier 304 also includes an inner zone plate 304, and a dual zone bladder holder 306 that is configured to hold the inner zone plate 304 and bladder 302. When assembled, the inner zone plate 304 is sandwiched between the bladder 302 and the dual zone bladder holder 306.

The inner zone plate 304 affixes to the dual zone bladder holder 306 by attachment screws 310, through holes 312 in the dual zone bladder holder 306 and holes 314 in the inner zone plate 394. Pneumatic elbows 308 are connected the inner zone bladder 302 through holes 316 and extend through openings 320 in the dual zone bladder holder. The bladder 302 has a raised ring 322 which, when engaged with the inner zone plate 304 when assembled seals an inner air space between the bladder 302 and the inner zone plate 304 at an inner region 324 of the bladder 302. The pneumatic elbows 308 can be connected with pneumatic lines (not shown) that can either supply air pressure to or apply a vacuum to the air space 324.

The air or vacuum provided by the pneumatic elbows 308 provides a twofold function. The bladder has holes 326. In order to determine if a wafer is in place on the carrier, a vacuum can be applied through one or more of the elbows 308. If the wafer is in place on the opposite side of the bladder 302 (as shown in FIG. 3) it will block the holes 326 and the vacuum will be detected indicated that the lapping can proceed. However, if there is no wafer in place on the bladder, the holes 326 will allow the vacuum to break. A detection of the break in vacuum will indicate that polishing cannot proceed. This, therefore, provides a safety mechanism to prevent operation of the CMP tool without a wafer being in place.

The elbows also provide another function with regard to ensuring uniform polishing across the wafer surface. As discussed above, during lapping of very hard wafers such as the AlTiC wafers used for the manufacture of sliders, the center of the wafer can be polished at a slower rate than the outer portions of the wafer. If a wafer is in place in the tool, the holes 326 will be blocked due to the presence of the wafer thereon. During lapping, air pressure is supplied through the pneumatic elbows 308 to the air space 324 between the bladder 302 and the inner zone plate 304. As can be seen, this will cause only the inner portion of the bladder 302 to balloon outward, leaving the outer portions of the bladder 302 unpressurized. This outward ballooning of only the inner portion of the bladder will cause only the inner portion of the wafer to be pushed outward, thereby providing increased pad pressure and thereby increasing the polishing rate at the inner, center portions of the wafer.

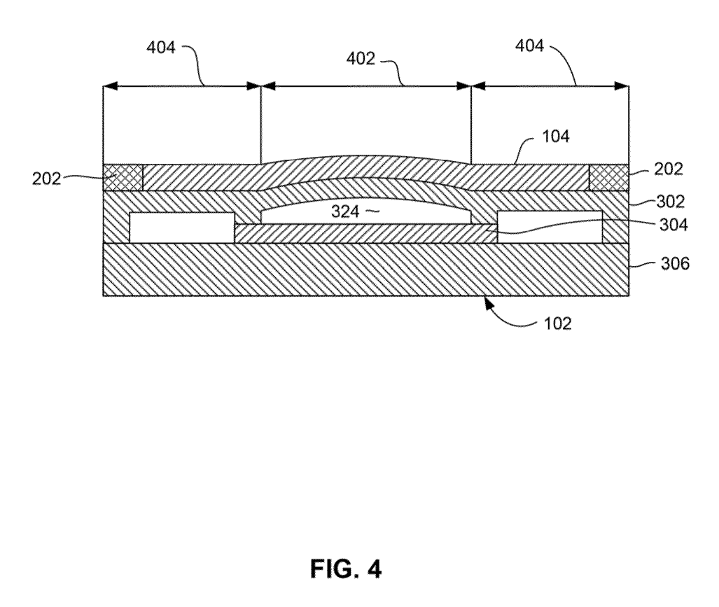

This can be better understood with reference to FIG. 4, which shows a cross sectional view of a carrier 106 with a water held thereon within the ring 202 on the surface of the bladder 302. The air space 324 is pressurized, causing an inner portion 402 of the bladder 302 to bow outward. This in turn causes a corresponding tuner portion of the wafer to bow outward as well. However, the outer portions 404 of the bladder 302 are not pressurized and do not bow outward.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A wafer carrier, comprising:
a bladder having an inner portion and an outer portion; and
a pneumatic supply configured for pressurizing the inner portion of the bladder without pressurizing an outer portion of the bladder.

2. The wafer carrier as in claim 1 wherein the bladder has a surface configured to hold a wafer thereon.

3. The wafer carrier as in claim 1, further comprising:
a bladder holder; and
an inner zone plate located between the bladder and the bladder holder, the inner zone plate being configured to engage the bladder so as to form an air space at the inner portion of the bladder.

4. The wafer carrier as in claim 3 wherein the pneumatic supply is connected with the inner zone plate to supply pneumatic pressure to the air space.

5. The wafer carrier as in claim 3 wherein the pneumatic supply is connected with and extends through the inner zone plate to supply pneumatic pressure to the air space.

6. The wafer carrier as in claim 3 wherein the bladder has a raised ring that is configured to engage the inner zone plate so as to form the air space.

7. The water carrier as in claim 6 Wherein the raised ring defines a boundary between the inner portion and the outer portion.

8. The wafer carrier as in claim 1 wherein the pneumatic supply is configured to also provide a vacuum to detect a presence or absence of a wafer on the bladder.

9. The wafer carrier as in claim 8 Wherein the bladder is configured with holes to provide a break in vacuum if no wafer is present on a surface of the bladder.

10. The water carrier as in claim 3 further comprising a pneumatic elbow connected with and extending through the inner zone plate and extending through an opening in the bladder holder.

11. A chemical mechanical polishing tool, comprising:
a wafer carrier that includes a bladder having an inner portion and an outer portion, and a pneumatic supply configured for pressurizing the inner portion of the bladder without pressurizing an outer portion of the bladder;
a polishing pad configured for movement over a surface of the wafer carrier; and
a slurry supply configured to supply a slurry over the surface of the wafer carrier.

12. The chemical mechanical polishing tool as in claim 11 wherein the wafer carrier is configured to hold a workpiece wafer thereon and wherein the polishing pad is arranged to move over a surface of the workpiece wafer.

13. The chemical mechanical polishing tool as in claim 11, wherein the bladder has a surface configured to hold a water thereon.

14. The chemical mechanical polishing tool as in claim 11 wherein the water carrier further comprises:
a bladder holder; and
an inner zone plate located between the bladder and the bladder holder, the inner zone plate being configured to engage the bladder so as to form an air space at the inner portion of the bladder.

15. The chemical mechanical polishing tool as in claim 14, wherein the pneumatic supply is connected with the inner zone plate to supply pneumatic pressure to the air space

16. The chemical mechanical polishing tool as in claim 14, wherein the pneumatic supply is connected with and extends through the inner zone plate to supply pneumatic pressure to the air space.

17. The chemical mechanical polishing tool as in claim 14, wherein the bladder has a raised ring that is configured to engage the inner zone plate so as to form the air space

18. The chemical mechanical polishing tool as in claim 17, wherein the raised ring defines a boundary between the inner portion and the outer portion.

19. The chemical mechanical polishing tool as in claim 11, wherein the pneumatic supply is configured to also provide a vacuum to detect a presence or absence of a wafer on the bladder.

20. The chemical mechanical polishing tool as in claim 19, wherein the bladder is configured with holes to provide a break in vacuum if no wafer is present on a surface of the bladder.

21. The chemical mechanical polishing tool as in claim 14, further comprising a pneumatic elbow connected with and extending through the inner zone plate and extending through an opening in the bladder holder.
